(19) United States
(12) Patent Application Publication
(10) Pub. No.: US 2016/0059490 A1
(43) Pub. Date: Mar. 3, 2016

(54) SYSTEM AND METHOD FOR BUILDING PARTS

(71) Applicant: STAFFORD MANUFACTURING CORP., Wilmington, MA (US)

(72) Inventor: Arthur Colgate Stafford, Bolton, MA (US)

(73) Assignee: STAFFORD MANUFACTURING CORP.

(21) Appl. No.: 14/476,278

(22) Filed: Sep. 3, 2014

(51) Int. Cl. B29C 67/00; G05B 15/02

(52) U.S. Cl. CPC B29C 67/0088; G05B 15/02; B33Y 50/02

(57) ABSTRACT

A system and method for building a part includes a universal member and a digital computer file for printing a custom member in a three dimensional printer. The universal member includes a first portion that abuts a second portion on the custom member when printed. The custom member is secured in the universal member to form a part. The universal member may be re-used and a new custom member printed if the needs of a customer change in the future.

### BACKGROUND OF THE INVENTION

1. Technical Field

The present invention relates generally to the field of constructing parts for machines. More particularly, the present invention relates to system and method for constructing parts. Specifically, the present invention relates to a system for building parts of a machine including a universal member and a computer file configured to print a custom member.

2. Background Information

A shaft collar is a part, usually in a machine, that generally wraps around a shaft and clamps thereon. The shaft collar is designed to retain something to the shaft or to retain the shaft to something else as the shaft rotates or moves. One exemplary use of a shaft collar is to retain a gear at a desired location along a rotating shaft. Shaft collars should provide even distribution of clamping forces on the surface of the shaft.

Some shaft collars are known as two-piece shaft collars. These two-piece shaft collars are still generally cylindrical in shape but they split longitudinally along one side via a pivot pin to allow a clamshell-like opening. This offers additional versatility and convenience over a fixed single piece shaft collar. The split design is easily installed and disassembled, reducing labor and downtime when adjustment, removal, or replacement is necessary.

### SUMMARY

Issues continue to exist with two-piece shaft collars inasmuch as they are usually constructed from a substantially single material and are rigidly formed to a single shaft diameter or shape. Thus, it would be beneficial if a device existed that had a universal outer collar portion that could receive a custom insert that would connect to any shaft shape or diameter the user needed to fit. Thus, the user could re-use the outer universal member or collar and simply replace the insert if it ever broke, or a new shaft needed to be used. The present invention addresses these and other issues.

In one aspect, the invention may provide a system for building a part, the system comprising: a universal member including a first portion, the first portion adapted to complimentarily engage a second portion on a custom member; and a computer file including code, the code adapted to print the custom member in a three dimensional printer.

In another aspect, the invention may provide a method for building parts, the method comprising the steps of: providing a universal member including a first portion from a supplier; and supplying a computer file, the computer file including code for printing a custom member on a three dimensional printer remote from the supplier.

In another aspect, the invention may provide a method for building a part, the method comprising the steps of: obtaining a universal member having a first portion; printing a custom member having a second portion; and abutting the first portion and the second portion to connect the custom member and the universal member and form the part.

In another aspect, an embodiment may provide a mechanical part comprising: a universal member including a first arcuate section connected to a second arcuate section, the first and second sections selectively movable relative to each other between an open and a closed position; a custom member secured by the universal member in the closed position defining a distinct aperture extending therethrough, the custom member printed on a three dimensional printer from a digital file supplied to a customer by a supplier.

In yet another aspect, an embodiment may provide a system and method for building a part including a universal member and a digital computer file for printing a custom member in a three dimensional printer. The universal member includes a first portion that abuts a second portion on the custom member when printed. The custom member is secured in the universal member to form a part. The universal member may be re-used and a new custom member printed if the needs of a customer change in the future.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic view of the system for building a part of the present invention including a universal member and a computer file adapted to print a custom member;

FIG. 2 is a schematic view of the system for building a part of the present invention in combination with a custom member printed on a three dimensional printer abutted with the universal member

FIG. 3 is a perspective view of the universal member abutted with the custom member to retain a shaft therein;

FIG. 4 is an exploded perspective view of the universal member and the custom member shown in an open position;

FIG. 5 is a cross section take along line 5-5 in FIG. 3;

FIG. 6 is a front view of an alternative embodiment of the custom member depicted a cross-shaped shaft aperture; and

FIG. 7 is a front view of an alternative embodiment of the custom member depicted a circular shaft aperture. Similar numbers refer to similar parts throughout the drawings.

### DETAILED DESCRIPTION

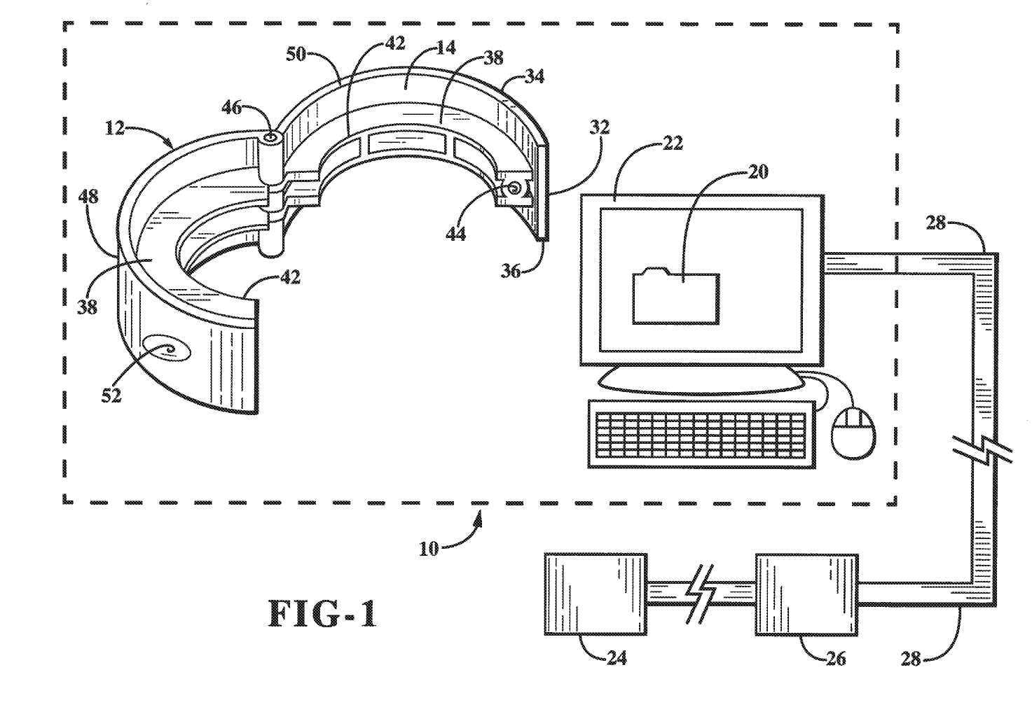

A system for building a part is depicted generally throughout FIGS. 1-7 as reference numeral 10. As depicted in FIG. 1, the system 10 for building a part includes a universal member 12 including a first portion 14, and further includes a digital computer file 20 including code adapted to print a custom member 18. The outer member 12 may be exchanged or re-used on a variety of different elements in a machine having unique cross sections.

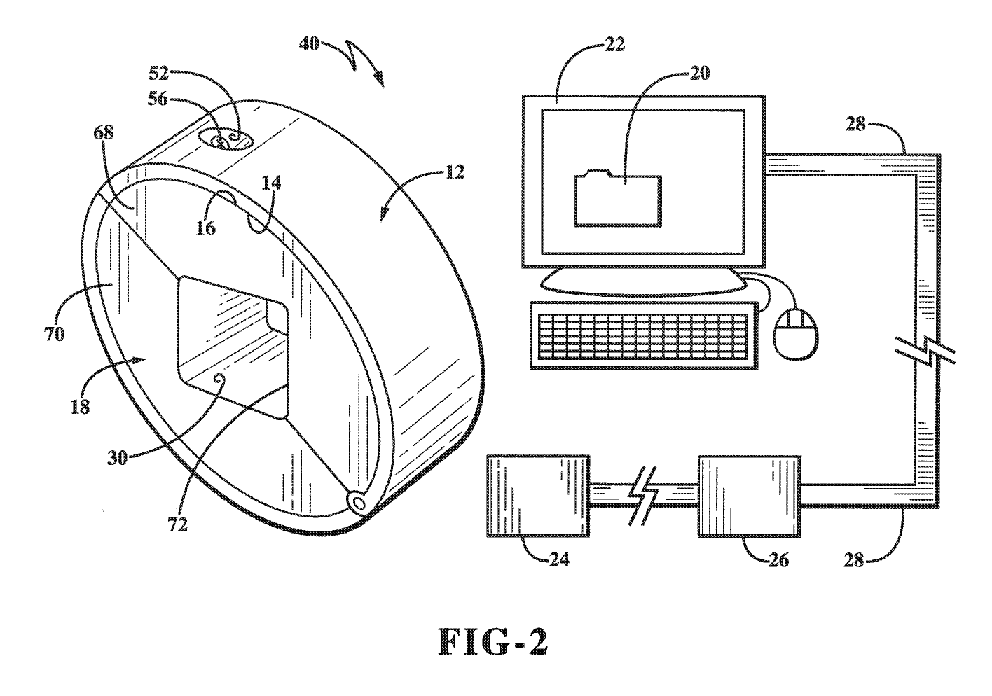

With continued reference to FIG. 1 and generally depicted in FIG. 2, the computer file 20 is stored on a supplier computer 22 or server and the computer file 20 includes code that is adapted to a print custom member 18 in a three dimensional printer 24 remote from system 10. File 20 may be created and saved in a program ordinarily associated with three dimensional printers.

Computer file 20 is configured to be hosted on a supplier website. The website permits downloading of the computer file 20 onto a customer computer 26 remote from the website. Once file 20 has been downloaded to a customer computer 26, customer may print custom member 18 in a three dimensional printer. As the custom member 18 is adapted to engage the universal member 12, the customer may then assemble custom member 18 and universal member 12 to build a part. Here, the assembled part is depicted generally as a shaft collar 54, but clearly other machine parts are contemplated.

The remoteness of customer computer 26 is indicated through the broken line connection 28 between customer computer 26 and a supplier computer 22. The connection 28 indicates that computers 22, 26 are electronically connected as one having ordinary skill in the electronic arts would understand such as, by way of non-limiting example, wireless connection via a network or the internet, but that computer 26 is located at a physical location remote from the supplier computer 22.

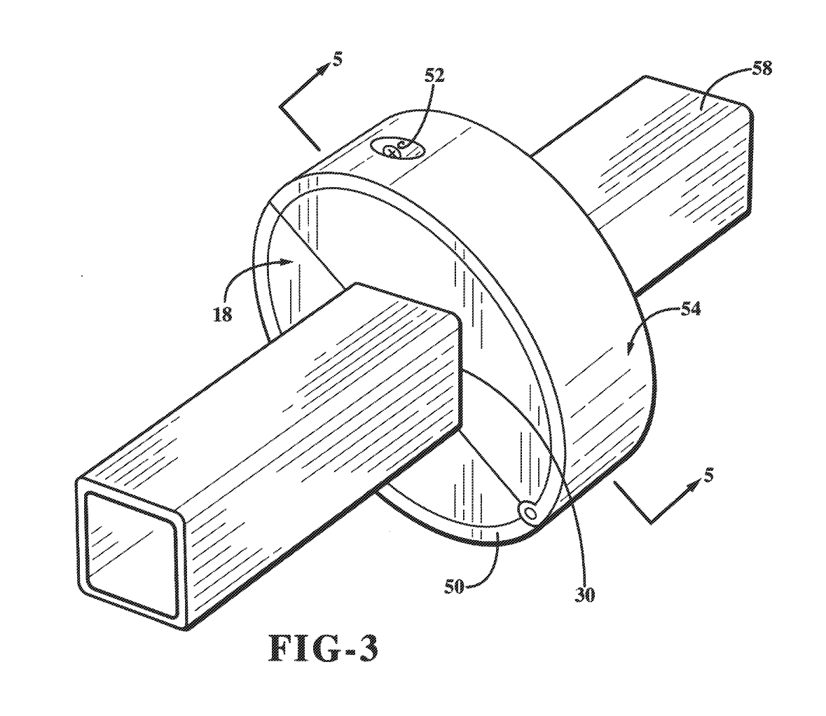

Supplier website preferably includes graphics, font, text, indicia, and other easily understood items for allowing a customer to download the computer file 20 containing the code for printing the custom member 18 in three dimensional printer 24. Additionally, in one particular embodiment, the website hosts a plurality of computer files. Each file of the plurality of files is associated with a corresponding or unique shape of custom member 18. In one particular embodiment, the files 20 contain code that the general second portion 16 on custom member 18 are substantially similar throughout each custom member. This allows any printed custom member 18 to engage universal member 12. Computer files 20 dictating the shape of custom member 18 vary and depend on the configuration of shaft aperture 30. The shaft aperture 30 (FIG. 2) is configured to receive a distinct shaft 58 (FIG. 3) configuration therethrough. The shaft aperture 30 will be described in greater detail below.

In another particular embodiment, the supplier website may permit uploading of a user file thereto. The user file uploaded to the supplier website may be generated utilizing a three dimensional scanner remote from the supplier website. Supplier website may choose to continue to host the generated file or may discard it as determined by the supplier.

Further, by way of non-limiting example, supplier computer 22 may include a processor, a memory, and input/output ports operably connected by a bus. In one example, the computer 22 may include a custom member logic configured to allow downloading of computer file 20 by a remote user computer 26 for printing custom member 18 in a remote three-dimensional printer 24. Remote refers to physical remote from supplier computer 22 albeit in electrical communication. In different examples, the custom member logic may be implemented in hardware, software, firmware, and/or combinations thereof. Thus, the custom member 18 logic may provide means (e.g., hardware, software, and firmware) for printing a custom insert of a part abutted to a universal member to collectively form a mechanical part having a universal member and a custom printed member secured therein. While the custom member logic is contemplated as a hardware component attached to the bus, it is to be appreciated that in one example, the custom member logic could be implemented in the processor.

Generally describing an example configuration of the computer 22, the processor may be a variety of various processors including dual microprocessor and other multi-processor architectures. A computer memory may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk may be operably connected to the computer 22 via, for example, an input/output interface (e.g., card, device) and an input/output port. The disk may be, for example, a magnetic disk drive, a solid state disk drive, a floppy disk drive, a tape drive, a Zip drive, a flash memory card, and/or a memory stick. Furthermore, the disk may be a CD-ROM, a CD recordable drive (CD-R drive), a CD rewriteable drive (CD-RW drive), and/or a digital video ROM drive (DVD ROM). The memory can store a process and/or a data, for example. The disk and/or the memory can store an operating system that controls and allocates resources of the computer 22.

The bus may be a single internal bus interconnect architecture and/or other bus or mesh architectures. While a single bus is illustrated, it is to be appreciated that the computer 22 may communicate with various devices, logics, and peripherals using other busses (e.g., PCIE, SATA, Infiniband, 1394, USB, Ethernet). The bus can be types including, for example, a memory bus, a memory controller, a peripheral bus, an external bus, a crossbar switch, and/or a local bus.

The computer 22 may interact with input/output devices via the i/o interfaces and the input/output ports. Input/output devices may be, for example, a keyboard, a microphone, a pointing and selection device, cameras, video cards, displays, the disk, the network devices, and so on. The input/output ports may include, for example, serial ports, parallel ports, and USB ports.

The computer 22 can operate in a network environment and thus may be connected to the network devices via the i/o interfaces, and/or the i/o ports. Through the network devices, the computer 22 may interact with a network. Through the network, the computer 22 may be logically connected to remote computers, such as the user computer 26. Networks with which the computer 22 may interact include, but are not limited to, a local area network (LAN), a wide area network (WAN), and other networks. The networks may be wired and/or wireless networks.

Further, “logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

With primary reference to FIG. 2, in one particular embodiment, system 10 is configured to be used in combination 40 with the custom member 18 printed from computer file 20. Custom member 18 includes the second portion 16. The first portion 14 on universal member 12 complimentarily engages the second portion 16 on custom member 18 and in one particular embodiment first and second portion 14, 16 contact by a frictional interference fit. The combination 40 of system 10 and custom member 18 includes an abutment portion at the contact location of first portion 14 and second portion 16. Additionally, the combination 40 may further include the three dimensional printer 24 that is configured to print the custom member 18 thereon, from computer file 20.

As depicted in FIG. 3, a part or collar 54 is created when universal member 12 is in the closed position securing custom member 18 therein. Shaft receiving aperture 30 is defined an edge 72 on member 18 of the collar 54. Collar 54 is configured to slide onto a shaft 58 through aperture 30 and be secured thereto. Collar 54 acts as a shaft collar to secure a variety of components, such as gears at a desired location in order to make a mechanical operation run.

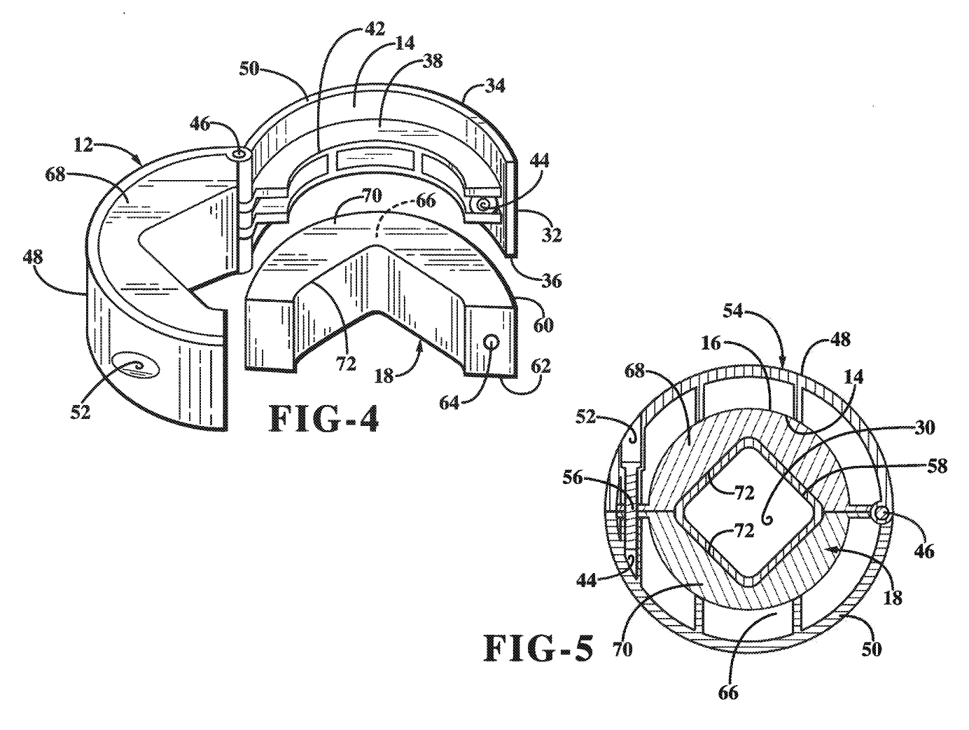

As depicted in FIG. 4 and FIG. 5, universal member 12 includes a generally annular sidewall 32 extending from a first edge 34 to a second edge 36. Annular sidewall 32 defines a generally convex outer surface and a generally concave inner surface. A tongue 38 extends inwardly from convex inner surface towards a tongue edge 42. A bolt receiving bore 44 is formed in one end of tongue 38 and configured to receive a bolt 56 therethrough for locking universal member 12 into a closed position.

Universal member 12 includes a pivot pin 46 dividing universal member 12 into a first semi-circular or arcuate collar section 48 and a second semi-circular or arcuate collar section 50 that are selectively opened and closed by a user about pin 46. Additionally, while a securing member is shown as pivot pin 46, other securing members are contemplated.

A bolt receiving aperture 52 is formed in the convex outer surface of first section 48. Aperture 52 is aligned with bore 44 when sections 48, 50 are in the closed position. When closed, first portion 14 is configured to contact and engage a complimentary second portion 16 on custom member 18 and at the abutment location.

Custom member 18 includes a top edge 60 spaced apart from a bottom edge 62, a bore 64 extending therethrough, and a groove 66. Furthermore, custom member 18 may include two generally semi-circular or arcuate sections 68, 70. When assembled, the top edge 60 is closely adjacent top edge 34, and preferably the two are coplanar. Similarly, bottom edge 62 is closely adjacent, and preferably coplanar with bottom edge 36 when assembled. Groove 66 receives tongue 38 therein and preferably the two respective surfaces contact and create a frictional interference fit. Bore 64 is aligned with bore 54 and aperture 52 when assembled allowing bolt 56 to extend therethrough. Further, the aperture edge 72 defines the shape of aperture 30.

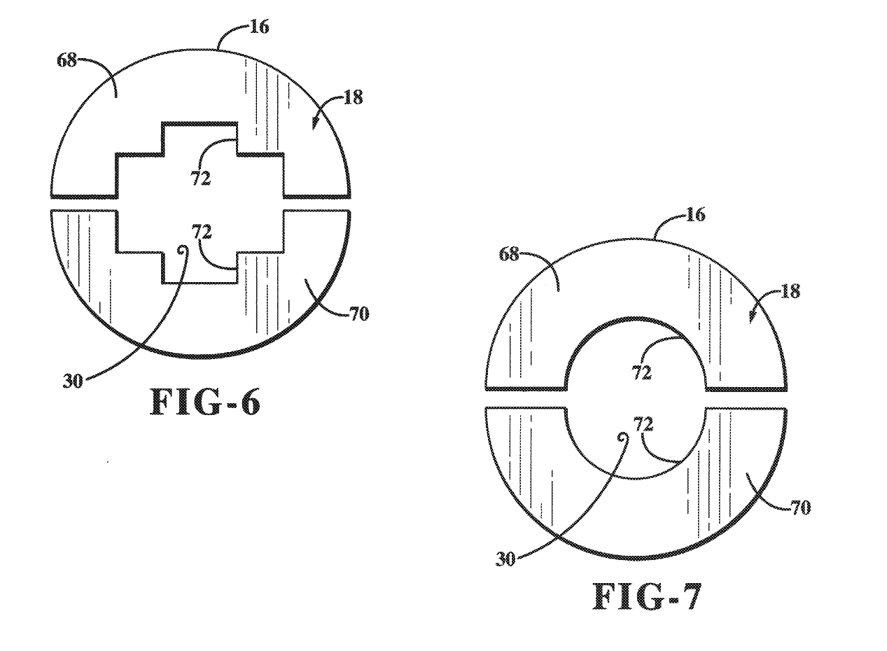

As depicted in FIG. 6 and FIG. 7, aperture edge 72 varies depending on code contained on computer file 20, which results in differently shaped apertures based on a desired application. For example, the aperture edge may be adjusted so that custom member 18 may be printed in a three dimensional printer in a manner that defines a variety of shaft apertures 30. Apertures 30 vary depending on the size and shape of shaft 58. Further, aperture 30 may vary in shape depending on the strength of the part or collar 54 needed. For example, if a high torque application is required, a cross pattern similar to that of FIG. 6 may be printed, however, for lower torque operations, a circular aperture similar to that of FIG. 7 may suffice. Common to all custom members 18 is that they include a second portion 16 that is configured to mateably engage and contact a first portion 14 on universal member 12 at an abutment location.

In accordance with one aspect of the present invention, aperture 30 can be a variety of different shapes and sizes that it allows a user to download computer file 20 including code having the shape of custom member 18 written into the code. The user can obtain a single outer universal member 12 and then print a custom member 18 and assemble the two pieces together forming a part. The outer member 12 may be exchanged and used on a variety of different shafts that may have unique cross sections when the custom member 18 is no longer necessary.

In accordance another aspect of the present invention, system 10 permits a universal part supplier to send and sell a universal member to a customer. Here, the universal member 12 was depicted as an outer annular portion of a shaft collar. Then the supplier provides a computer file containing code for printing a custom member on a three dimensional printer at the customer's location. Here, the custom member was depicted as an inner portion of a shaft collar defining a shaft aperture 30 complementary to a shaft 58. The customer then can assemble the part themselves at their location. Further, the universal member 12 may be re-used should the customer's need change and all they have to do is re-download a new computer file with code associated with a different custom member 18. For example, if the customer gets a new shaft 58 having a different diameter, or a different cross section, the customer can download and print a new custom member 18 and assemble it into the universal member 12 to build a new part.

In operation, system 10 is created by constructing member 12 in manner that it will have sufficient strength to meet the mechanical requirements of the machine it will be attached to. It is contemplated that universal member 12 will be constructed from a high strength material, such as stainless steel, or the like. Universal member 12 may be formed through forged, extruded, welded, machined, die cast, or injection molded processes, or the like, as one having skill in the art would understand. System 10 is also created by generating computer file 20 for storing on the supplier's computer 22 or server and hosted on the supplier's website. Computer file 20 is generated in a computer program capable of modeling, such as AutoCAD, and able to be printed in a three dimensional printer.

In operation, a supplier, such as a manufacturer or distributor, provides the universal member 12 of system 10 to a customer. The step of providing the universal member 12 to the customer occurs through ordinarily commercial manners. Then, the supplier supplies the computer file 20 to a customer. The supplier then instructs the customer to print the custom member from the computer file in a three dimensional printer. The customer then prints the custom member 18 in a three dimensional printer remote from the supplier. And additionally, the supplier instructs the customer to assemble a part by abutting a first portion on the custom member with a second portion on the custom member.

The supplier may also host the computer file 20 on its supplier website. The supplier's website allows the remote customer to download the file from the website for printing the custom member from the file on their three dimensional printer.

In operation and with respect to the customer's perspective, a method for building a part includes the steps of the customer obtaining a universal member 12 having a first portion 14. Preferably, customer obtains universal member from the supplier. It is contemplated that the customer will download the file 20 to their computer 26 via internet connection 28 to the supplier's website or server. The customer then prints the custom member 18 having a second portion 16. Preferably, the customer prints the custom member from the digital computer file 20 in the three dimensional printer 24. Then the customer or an end user, such as a mechanic, abuts the first portion 14 and the second portion 16 to connect the custom member 18 and the universal member 12 and form a part, herein shown as shaft collar 54.

Additionally, with reference to some remaining matters, while universal member 12 is depicted as an outer annular portion of shaft collar 54, it is to be understood that the universal member 12 can be a wide variety of apparatus components that, when combined with a custom member 18 printed on a three dimensional printer, form a part. The custom member 18 will be made from a material capable of being printed in a three dimensional printer, such as thermoplastics, HDPE, eutectic metals, rubber, various clays, plasticine, RTV silicone, porcelain, metal clay, metal alloys, stainless steel, plaster, plastic film, photopolymers, and other polymers amongst others. When universal member 12 secures custom member 18 therein, the overall strength of the part will be similar to that of a part constructed from a single material, for example a shaft collar made entirely out of stainless steel.

Further, the term “customer” refers to an individual or business entity that is not the supplier. The customer can be an end user, or a distributor middle-man who then sells to another third party.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A system for building a part, the system comprising:
a universal member including a first portion, the first portion adapted to complimentarily engage a second portion on a custom member; and
a computer file including code, the code adapted to print the custom member in a three dimensional printer.

2. The system of claim 1, further comprising:
a supplier website hosting the computer file, the website adapted to permit downloading of the computer file onto a customer computer remote from the website.

3. The system of claim 2, further comprising:
a plurality of computer files hosted on the website, each file associated with a custom member shape, the custom member configured to engage the universal member when the file is printed in a three dimensional printer and each file associated with a distinct shaft aperture.

4. The system of claim 1, further comprising:
a supplier website for uploading the computer file thereto, the computer file generated remotely from the supplier website.

5. The system of claim 1, further comprising:
an annular sidewall on the universal member; and
a tongue on the sidewall, the tongue adapted to frictionally engage a complementary groove on the custom member to couple the universal member to the custom member.

6. The system of claim 1, further comprising:
a first arcuate section on the universal member;
a second arcuate section on the universal member; and
a securing member at one end of each first and second arcuate member connecting the first and second arcuate members together forming an annular configuration.

7. The system for building a part of claim 1, further comprising:
a custom member including a second portion, the custom member printed from the computer file; and
an abutment portion at the contact of the first portion and the second portion.

8. The system of claim 7, further comprising:
an aperture formed in the custom member defined by an edge, the aperture having a cross section configuration as one of a circle, rectangle, and a cross.

9. The system of claim 7, further comprising:
a first generally semi-circular section on the custom member; and
a second generally semi-circular section on the custom member,
wherein a shaft receiving aperture is formed by the circular alignment of the first and second sections secured in the universal member.

10. The system of claim 7, further comprising:
a remote three dimensional printer configured to print the custom member from the computer file.

11. The system of claim 7, further comprising:
a first bolt receiving bore formed in a first arcuate section on the universal member;
a bolt aperture extending through a second arcuate section on the universal member aligned with bore when the universal member is in a closed position;
a second bolt receiving bore formed in a custom member aligned with the first bore and the bolt aperture; and
a bolt extending through the bolt aperture, the second bore, and the first bore to secure the custom member within the universal member.

12. A method for building parts, the method comprising the steps of:
providing a universal member including a first portion from a supplier; and
supplying a computer file to a customer, the computer file including code for printing a custom member on a three dimensional printer remote from the supplier.

13. The method of claim 12, further comprising the step of hosting the computer file on a supplier website, the website adapted to allow a remote customer to download the file from the website and print a custom member from the file on a three dimensional printer.

14. The method of claim 12, further comprising the step of instructing a customer to print a custom member including a second portion from the computer file in a three dimensional printer.

15. The method of claim 12, further comprising the step of instructing a customer to assemble a part by abutting the first portion on the universal member with a second portion on the custom member.

16. A method for building a part, the method comprising the steps of:
obtaining a universal member having a first portion;
printing a custom member having a second portion;
abutting the first portion and the second portion to connect the custom member and the universal member and form the part.

17. The method of claim 16, further comprising the step of using a digital file to print the custom member.

18. The method of claim 17, further comprising the steps of:
providing the digital file to a three-dimensional printer; and
printing the custom member with the three-dimensional printer.

19. The method of claim 17, further comprising the steps of:
obtaining the universal member from a supplier; and
downloading the digital file from the supplier.

20. A mechanical part comprising:
a universal member including a first arcuate section connected to a second arcuate section, the first and second sections selectively movable relative to each other between an open and a closed position;
a custom member secured by the universal member in the closed position defining a distinct aperture extending therethrough, the custom member printed on a three dimensional printer from a digital file supplied to a customer by a supplier.
